(19) United States
(12) Patent Application Publication
(10) Pub. No.: US 2004/0143469 A1
(43) Pub. Date: Jul. 22, 2004

(54) Recruiting system accessible by university staff, employers and students

(76) Inventors: Greg Lutz, Braintree, MA (US); Paul De Verna, Charlestown, MA (US); Dave Rodger, Arlington, MA (US); Alexis Gentile Comrack, Charlestown, MA (US); Jeff Tudor, Walpole, MA (US); Charles Pendleton, Marblehead, MA (US)

Correspondence Address: DUANE MORRIS, LLP, IP DEPARTMENT, ONE LIBERTY PLACE, PHILADELPHIA, PA, 19103-7396, US

(21) Appl. No.: 10/702,267

(22) Filed: Nov. 5, 2003

Related U.S. Application Data
(60) Provisional application No. 60/429,708, filed on Nov. 27, 2002.
(60) Provisional application No. 60/488,966, filed on Jul. 21, 2003.

(51) Int. Cl. G06F 17/60

(52) U.S. Cl. 705/7

(57) ABSTRACT

A university recruiting system and database allow collaboration of university career center staff, university students, and employers. Career center software functions enable career center staff to create and manage university student accounts and employer accounts. Employer software functions enable the employers to create job postings, deploy targeted job postings across multiple schools, access university student profiles and conduct candidate search across multiples schools, and manage job applications accessible by multiple schools. University student software functions enable the students to create student profiles, upload job search related documents, and perform job searches across multiple job listings and job content repositories.

This application claims the benefit of U.S. Provisional Patent Application Nos. 60/429,708, filed Nov. 27, 2002 and 60/488,966, filed Jul. 21, 2003.

### FIELD OF THE INVENTION

The present invention relates to the field of recruiting, and more specifically university recruiting within and across a network of university career center staff, employers, and university students.

### BACKGROUND

Employers use a wide variety of applications and techniques to aid in the recruiting of talent needed to grow and develop their organizations. The applications and techniques include:

The use of recruiting application software, often integrated into the employer's corporate web site

General purpose job posting and resume searching systems

Recruiting agencies

Specialty and niche market recruiting applications

Recruiting for university-educated talent is a specialized need that is not well served by the generally available applications and techniques. The university talent pool is one where the candidates (students) are inexperienced as workers, but also, and more importantly, inexperienced as job seekers. University career centers and their staff perform a pivotal role connecting their students to prospective employers. In this role, career center staff guide and develop their students into becoming effective job seekers and they are often instrumental in enabling students to successfully secure their first permanent employment opportunity. Career center staff play an additional role in strengthening the university brand. To this end, career center staff are motivated to attract employers who are interested in long-term recruiting relationships with the university. Career center staff are also motivated to help students identify with the university brand as a basis for future networking, career development, and alumni participation in the university's affairs.

Employers face many challenges with university recruiting, especially those that recruit at multiple universities nationwide. Employers with a recruiting relationship at a university will typically utilize the school's selected university recruiting application to post job opportunities, search for resumes, schedule on-campus visits, select candidates for interviews, schedule candidates for interviews, make offers to candidates, and communicate with students and career center staff.

One problem with these traditional university recruiting applications is that employers must interact with each university separately, often being required to use university-specific application software where the functions and data requirements vary significantly from university to university. This process is an extremely inefficient one, as each task must be repeated for each university. This means duplicate, time-consuming efforts for the employer. Employers are often forced to maintain separate system access accounts for each university, resulting in the need to manage and secure multiple user names and passwords and enter data repeatedly into each school system. The dis-integration of this process, from the employer's perspective, not only makes it difficult to execute the recruiting process efficiently, but it reduces the effectiveness of the consideration and evaluation of candidates across universities.

Another problem with university recruiting is that career center staff have a need to tailor the recruiting experience to meet the needs of the university culture, the students, and the employers. And meeting this need must be done in a way that maintains the workflow integration that employers require.

Another problem with university recruiting is that career center staff have a need to make available to their students additional sources of relevant and qualified job opportunities that reach beyond those provide by employers having recruiting relationships with the university.

Another problem with university recruiting is that employers have a need to access a network for job postings and a pool of students seeking job opportunities that reaches beyond those provide by universities having recruiting relationships with the employer.

In either case, typical university recruiting applications provide a means for university career center staff, university students and employers to interact within each other but solely within the context of a single university.

### SUMMARY OF THE INVENTION

A university recruiting system and database allows collaboration of university career center staff, university students, and employers. A career center means enables career center staff to create and manage university student accounts and employer accounts. An employer means enables the employers to create job postings, deploy targeted job postings across multiple schools, access university student profiles and conduct candidate search across multiples schools, and manage job applications accessible by multiple schools. A university student means enables the students to create student profiles, upload job search related documents, and perform job searches across multiple job listings and job content repositories.

### BRIEF DESCRIPTION OF THE DRAWINGS

FIG. 1 is an exemplary system component diagram of a university recruiting application and database implemented as an Internet Web Site.

FIG. 2 is an exemplary database diagram showing relationships between the affiliation table, the employer table, and the employer-affiliation table.

FIG. 3 is an exemplary database diagram showing relationships between the affiliation table, the job table, and the job-affiliation table.

FIG. 4 is an exemplary database diagram showing relationships between the resume book table, the document table, and the resume book-document table.

FIG. 5 is an exemplary database diagram showing the association between affiliation-specific, custom field values and jobs.

FIG. 6 is an exemplary database diagram showing the association between virtual affiliations and custom job content repositories.

FIG. 7 is an exemplary database diagram showing the association between virtual affiliations and custom resume books.

FIG. 8 is a screen shot of an exemplary display pane showing a career center that has added special-purpose job content repositories to their university environment in accordance with some embodiments of the invention.

FIG. 9 is a screen shot of an exemplary display pane showing a career center's set of available resume books in accordance with some embodiments of the invention.

FIG. 10A is a screen shot of an exemplary display pane showing a data entry form for the creation of an employer access account.

FIG. 10B is a screen shot of an exemplary display pane showing an employer linking recruiting relationship schools to the master account in accordance with some embodiments of the invention.

FIG. 11 is a screen shot of an exemplary display pane showing an employer's home page showing an integrated view of all linked (recruiting relationship) universities in accordance with some embodiments of the invention.

FIG. 12 is a screen shot of an exemplary display pane showing an employer's ability to post a single job to multiple, targeted universities, where the employer has a recruiting relationship, in accordance with some embodiments of the invention.

FIG. 13 is a screen shot of an exemplary display pane showing an employer's notification of job postings that need further annotation for a specific university in accordance with some embodiments of the invention.

FIG. 14 is a screen shot of an exemplary display pane showing an employer's ability to post a single job to multiple, targeted universities, where the employer does not have a recruiting relationship, in accordance with some embodiments of the invention.

FIG. 15 is a screen shot of an exemplary display pane showing an employer's integrated view of student resume searches across all universities in accordance with some embodiments of the invention.

FIG. 16 is a screen shot of an exemplary display pane showing an employer's integrated view of job postings across all universities in accordance with some embodiments of the invention.

FIG. 17 is a screen shot of an exemplary display pane showing an employer's integrated view of applicants for a particular job across all universities in accordance with some embodiments of the invention.

FIG. 18 is a screen shot of an exemplary display pane showing an employer's integrated view of a calendar of recruiting events across all universities in accordance with some embodiments of the invention.

FIG. 19A is a screen shot of an exemplary display pane showing a data entry form for the creation of a student access account.

FIG. 19B is a screen shot of an exemplary display pane showing a student's set of job application documents including resumes, cover letter and writing samples.

FIG. 19C is a screen shot of an exemplary display pane showing a student's choice of special-purpose resume books in accordance with some embodiments of the invention.

FIG. 19D is a screen shot of an exemplary display pane showing a data entry form for the, entry of student profile information.

FIG. 20 is a screen shot of an exemplary display pane showing a set of activity metrics for an employer's set of jobs.

### DETAILED DESCRIPTION

This application incorporates U.S. Provisional Patent Applications Nos. 60/429,708, filed Nov. 27, 2002 and 60/488,966 filed Jul. 21, 2003 by reference herein in their entireties, as though fully set forth herein.

A system and method that efficiently manages and facilitates the collaboration of employers, university career center staff, and university students is provided. In a computer system running a university recruiting application, it is advantageous to have workflow functions, and access to relevant data, that enable and optimize the activities of each of the participants who are accessing the system. This university recruiting application provides university career center staff the ability to establish and manage a network between themselves, students from the university, and employers that have recruiting relationships with the university. This university recruiting application provides employers the ability to integrate recruiting activities at universities where they have recruiting relationships as well as to integrate the posting of opportunities and searching for students across a broader network of universities, and students. This university recruiting application provides university students the ability to integrate searching and applying for career opportunities from within the university's context and across additional, more generally available sources of opportunities. In an illustrative implementation, this university recruiting application may be deployed on an Internet Web site that offers access to the above referenced functions and abilities to a large, collaborative network of universities, employers, and students.

This specification and the attached drawings provide a further understanding of the nature and advantages of some exemplary embodiments of this invention.

The challenges outlined above demonstrate that an improved system that provides the following two tiers of benefits are needed:

1) local control for university career center staff

2) connection and access to resources beyond the single university

Some exemplary embodiments of the present invention provide a unique university recruiting application. In an illustrative implementation, the system and methods contemplated may be realized as an Internet Web site that is accessed by university career center staff, university students and employers. Some embodiments may provide specialized graphical user interfaces and functions for these three types of parties accessing the recruiting application.

Some exemplary embodiments of the present invention provide that the business information entered and used by university career center staff, university students, and employers may reside in a database. This business information may be organized into an efficient database schema where business information is entered once and has the ability to be associated and referenced in a plurality of ways. One advantage of this invention is that business information for all university career centers, all university students, and all employers may reside in the same database thereby providing the most efficient way to enable interactions between a network of employers and university students.

Some exemplary embodiments of the present invention provide university career center staff with graphical user interfaces and functions that include but are not limited to the creation of university student access accounts, employer access accounts, definition of custom fields and custom field values, the creation and management of student resume books, the creation and management of employer interview schedules, the creation and management of university career event calendars, and creation and management of communications to university students and employers.

Some exemplary embodiments of the present invention provide employers with graphical user interfaces and functions that include but are not limited to the creation of a master account, the linking of university employer access accounts with the master account, the creation of job postings, the targeted deployment of job postings to one or more universities, the integrated view of all linked university accounts, the integrated view of all university recruiting calendars, the integrated view of all job postings across universities, the integrated view of all job applications across universities, the integrated searching for resumes across multiple universities and across multiple, specialized resume content repositories, and the creation and management of communications to university students. One advantage of these embodiments is the ability to provide employers with a highly integrated view of their recruiting activities across all universities.

Some exemplary embodiments of the present invention provide university students with graphical user interfaces and functions that include but are not limited to the creation and management of student profiles, the uploading and management of resumes and related job application materials, the creation and management of job applications, the searching for job opportunities across multiple, specialized job content repositories within their school environment and among other sources across the network.

A university recruiting application and database included in some embodiments of the invention allows university career center staff to create and manage a highly customized recruiting environment for their university. Some embodiments allow university students to access the recruiting environment for their specific, affiliated university as well as to access other job content repositories available within the broader recruiting application network. Some embodiments allow employers to access an integrated recruiting environment across all universities where the employer has recruiting relationships and to access student profile and resume repositories available within the recruiting application network, but outside the context of the recruiting relationship universities.

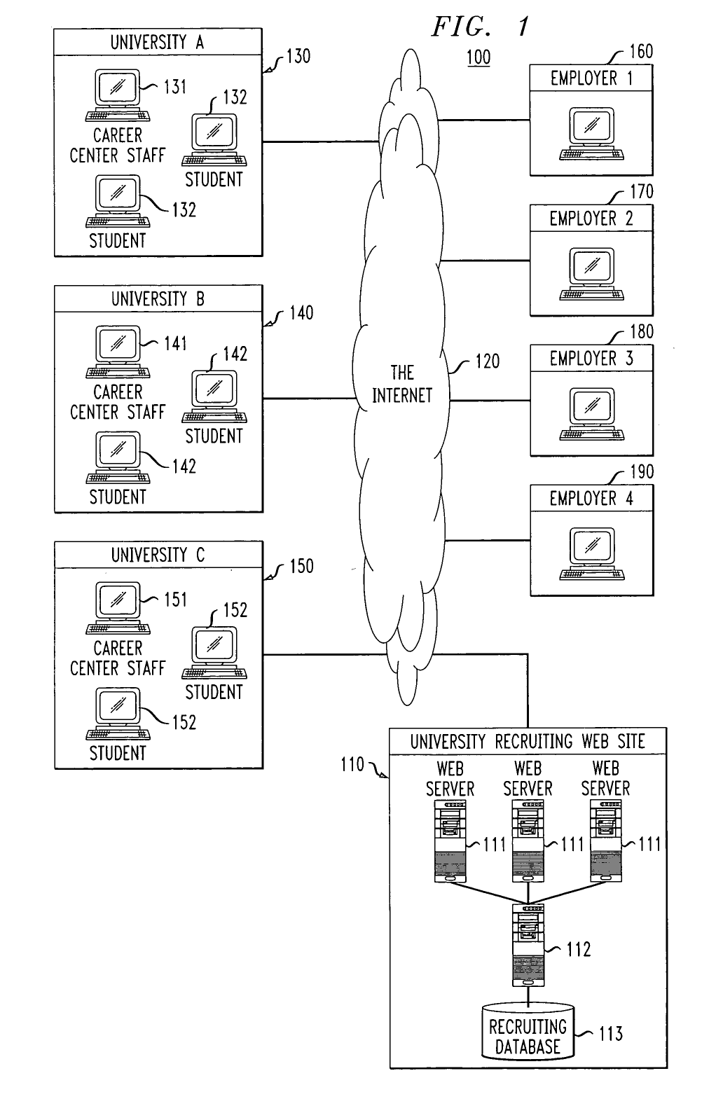

FIG. 1 shows a system 100 including an Internet Web site 110 and database 113 constructed in accordance with some embodiments of the invention. The Internet Web site 110 allows access to the university recruiting application by a potentially large number of universities 130, 140, 150 (including university career center staff 131, 141, 151 and university students 132, 142, 152) and a potentially large number of employers 160, 170, 180, 190. The business information for all users of the Internet Web site implementation of the university recruiting application is shown as being stored in a single database 113. In practice, it is possible that the business information may be stored in more than one database.

Several elements of the university recruiting application shown in FIG. 1 are conventional, well-known elements that need not be explained in detail herein. For example, the Internet 120 depicted in the drawing is understood to be a specific global network of interconnected networks. It should be understood that some embodiments are suitable for use with other networks including intranets, extranets, virtual private networks (VPN) and other networks not based on the TCP/IP protocol.

One embodiment may store in a database 113 the business information associated with the university recruiting application. Several elements of the database 113 may be conventional, well-known elements that need not be explained in detail herein. For example, the notion that related pieces of information may be stored as a collection of data fields comprising a record, which is added to a database table, is well known. It should be understood that some embodiments of the invention may be suitable for use with commercial and freely available database products as well as with other data storage methods and mechanisms.

In a preferred embodiment of the university recruiting application and database, the Internet Web site 110 may be implemented to include web server hardware 111 and database server hardware 112 comprising readily available Intel (or compatible) processor based equipment running the Red Hat version of the Linux operating system. The web server hardware 111 may be implemented to run with software comprising the Apache web server software and the Jrun java servlet engine. The database server hardware 112 may be implemented to run with database software comprising the Oracle 9i database engine and the Oracle JDBC client connection software. In a preferred embodiment of the university recruiting application and database, the recruiting functions for university career center staff, university students, and employers may be implemented as standard web-based applications using readily available web browser software such as Internet Explorer or Netscape. The web-based applications may be implemented using standard HTML, client-side Javascript, and server-side Java Server Pages. Java Server Pages may be implemented to conform to the Java 2 Platform Software Development Kit, Standard Edition and Java Server Pages specifications.

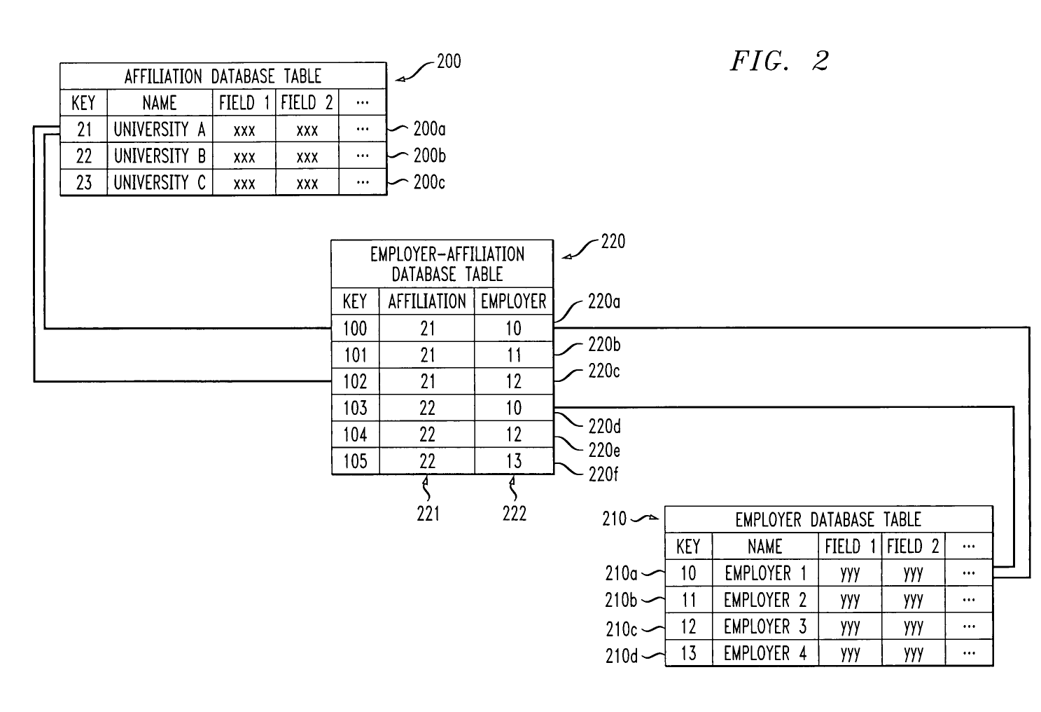

In some exemplary embodiments of the present invention, university business information may be stored in the database 113 as records in a table 200 that represents units of affiliation, shown in FIG. 2. For illustrative purposes, this table 200 will be referred to as the affiliation table. The affiliation table 200 includes but is not limited to one record 200a-200c for each university. Business information for all universities may be stored in the same table 200. Employer information may be stored in a database as records 210a-210d in an employer table 210. Business information for all employers may be stored in the same table 210. Employers may interact with more than one university. The most efficient way to represent these one-to-many relationships is to store the relationships in an employer-affiliation table 220 where there is one record 220a-220f for each relationship where the record includes a unique identifier 221 for the affiliation and a unique identifier 222 for the employer. FIG. 2 shows an illustrative implementation of this organization. It can be readily seen that, in this fashion, university records 200a-200c and employer records 210a-210d need only exist once in the database 113 and yet permit universities and employers to participate in a network containing many universities and many employers.

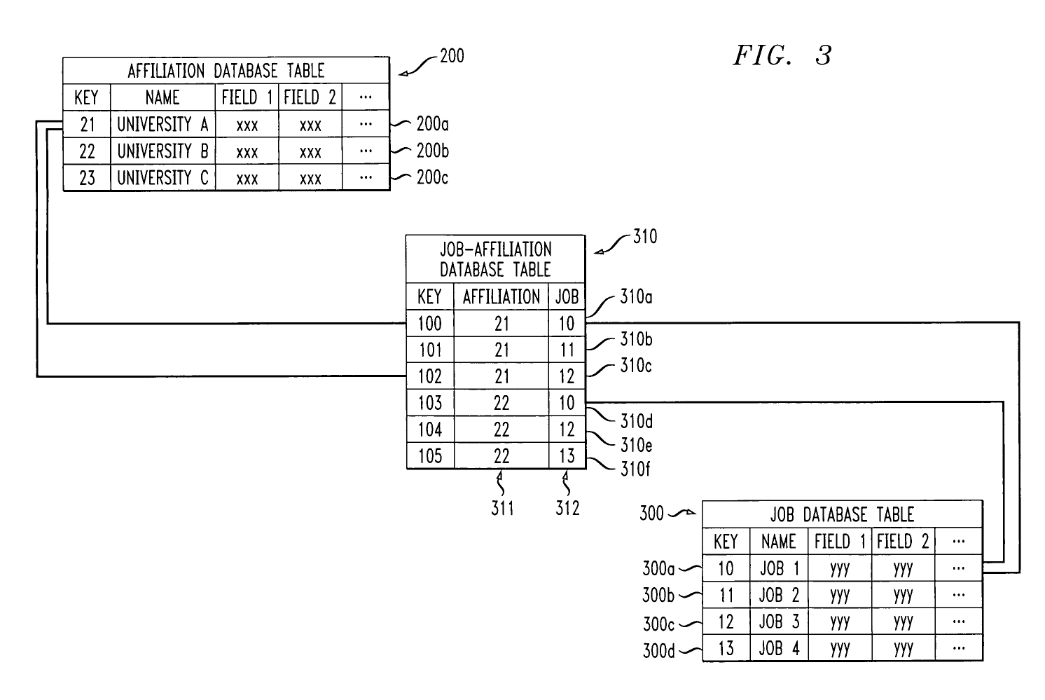

Likewise, business information for employers' job postings may be stored in a database as records in a job table 300, as shown in FIG. 3. Business information for all jobs may be stored in the same table 300. An employer may wish to seek applicants for a particular job from more than one university. The most efficient way to represent these one-to-many relationships is to store the relationships in a job-affiliation table 310 where there is one record 310a-310f for each relationship where the record includes a unique identifier 311 for the affiliation and a unique identifier 312 for the job. FIG. 3 shows an illustrative implementation of this organization. It can be readily seen that, in this fashion, university records 200a-200c and job records 300a-300d need only exist once in the database 113 and yet provide employers the means to allow these jobs to be available to a network of universities (including career center staff and university students).

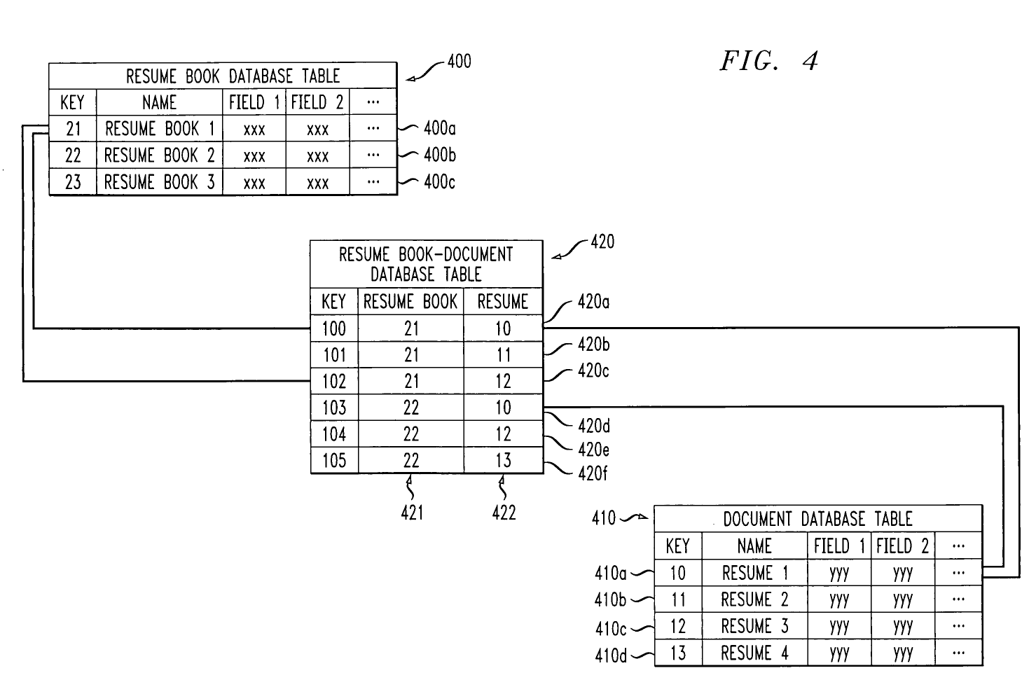

Business information for student resumes may be stored in a database as records 410a-410d in a document table or resume table 410. Business information for all resumes may be stored in the same table 410. University career center staff organize resumes into resume books. Business information for resume books may be stored in a database as records in a resume book table 400. Business information for all resume books may be stored in the same table 400. University students may wish to publish their resumes to one or more resume books. In this fashion, a single resume may be included in many resume books. The most efficient way to represent these one-to-many relationships is to store the relationships in a resume-book-document table 420 where there is one record 420a-420f for each relationship and where the record includes a unique identifier 421 for the resume and a unique identifier 422 for the resume book. FIG. 4 shows an illustrative implementation of this organization. It can be readily seen that, in this fashion, resume records 410a-410d need only exist once in the database 113 and yet provide students the means to allow these resumes to be available to a network of employers.

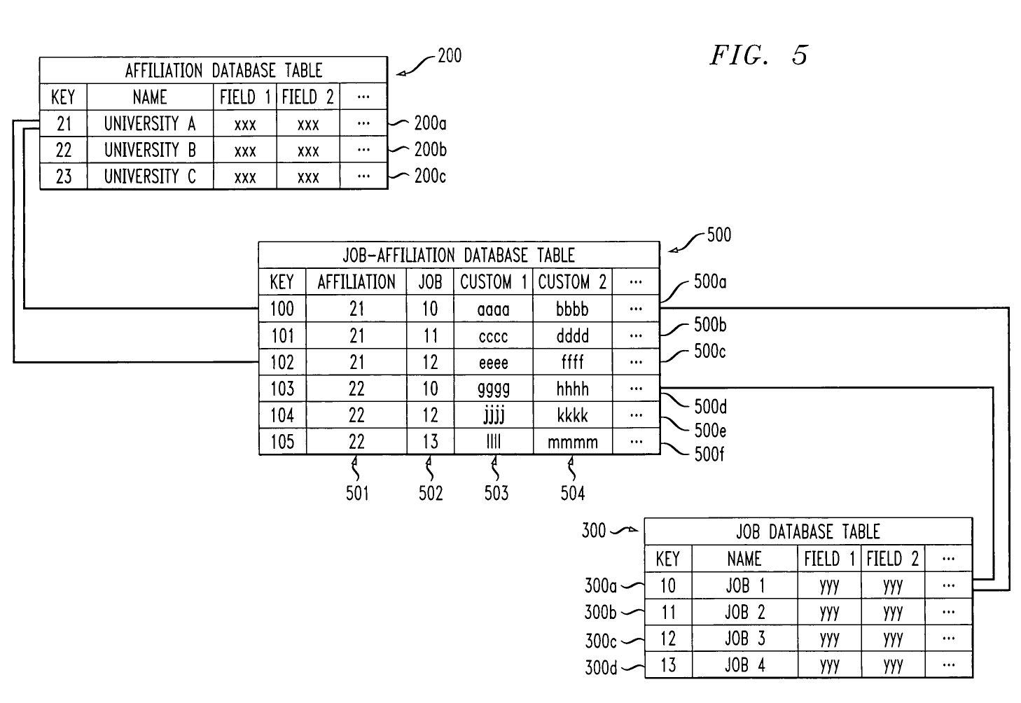

In some exemplary embodiments of the present invention, the university recruiting application provides for career center staff to define a highly customized recruiting environment for their university, as shown in FIG. 5. This customization may include unique data fields 503, 504 in such areas as job posting business information. This customization may also include custom value sets for data fields that are common across all universities. In these embodiments, employers who create job postings and deploy them to a targeted set of universities may need to annotate their job posting information for any one university with the correct data fields and data values that are peculiar to that university's customized environment. Since the job posting business information may exist in the database as a single record 300a-300d in a job table, the additional, university-specific business information for any one job posting may be stored as a record 500a-500f in a job-custom table 500. Each record 500a-500f in a job-custom table 500 may include a unique identifier 502 for the job, a unique identifier for the university 501, and relevant customized job business information in fields 503 and 504. FIG. 5 shows an illustrative implementation of this organization. It can be readily seen that a single job that has been deployed to a targeted set of universities may need additional customized business information for each university to which it has been deployed.

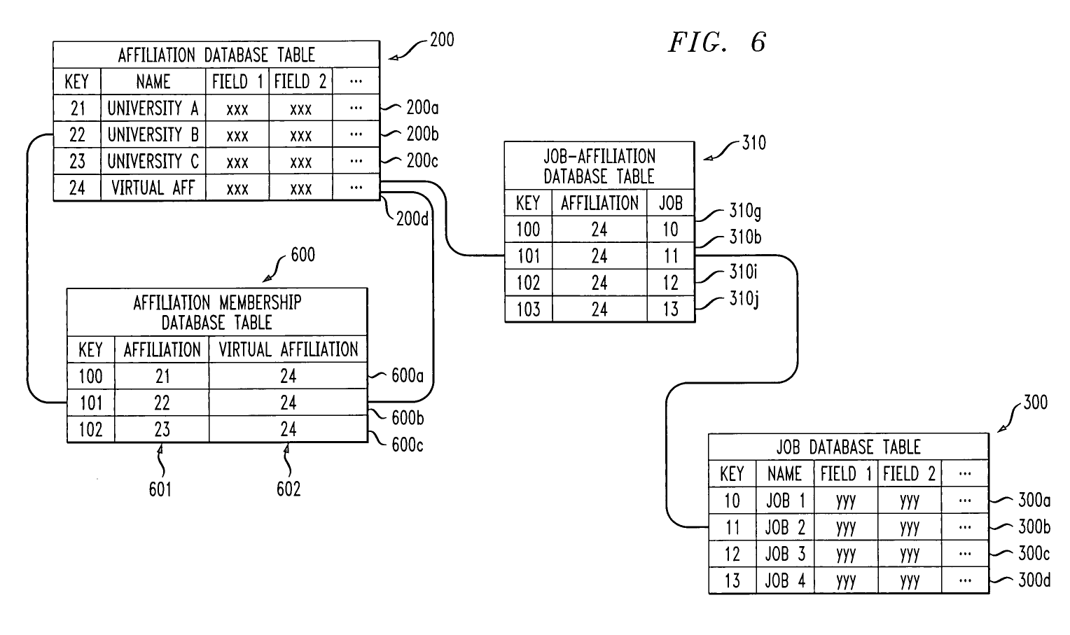

In some exemplary embodiments of the present invention, as shown in FIG. 6, business information for the university recruiting application may be organized to provide one or more special-purpose job posting content repositories. These special-purpose job posting content repositories may be available to a plurality of universities and not just to any one university. In some embodiments, special-purpose job content repositories may be created through the establishment of a virtual affiliation. A plurality of universities may be associated with a single virtual affiliation; any association between the virtual affiliation and an employer, job or resume book applies to all of the universities associated with that virtual affiliation. A virtual affiliation may be created by adding a record 200d to the affiliation table 200. Although FIG. 6 only shows a single virtual affiliation in the affiliation database table 200, any number of virtual affiliations may be included. An affiliation membership database table 600 stores the information associating a plurality of affiliations with a virtual affiliation. Although the example only shows information for one virtual affiliation, there may be membership information for any number of virtual affiliations in a single table 600. Jobs that are deployed to targeted sets of universities may also be deployed to one or more of the virtual affiliations. This business information may be represented as records 310g-310j in the job-affiliation table 310. The format for targeting a job to a virtual affiliation in the job affiliation database table 310 can be the same as that used for targeting a job to an affiliation, shown in FIG. 3. Universities and virtual affiliations may be associated with other affiliations or virtual affiliations. In this fashion, a university may be granted access to other affiliations and their associated job posting content repositories as well as their resume books. The most efficient way to represent these one-to-many relationships is to store the relationships in an affiliation-membership table 600, where there is one record 600a-600c for each relationship, and where the record includes a unique identifier 601 for the owner affiliation and a unique identifier 602 for the virtual affiliation. FIG. 6 shows an illustrative implementation of this organization. It can be readily seen that a plurality of job posting content repositories can be created network wide and that this provides for many opportunities for universities (career center staff and students) and for employers to interact beyond the scope of a single university.

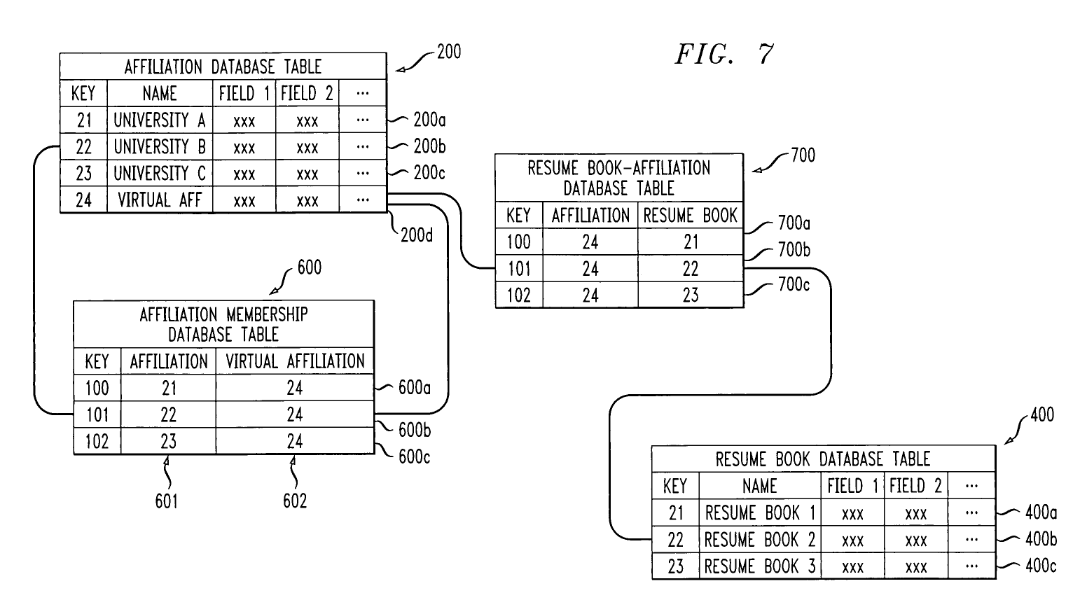

In some exemplary embodiments of the present invention, as shown in FIG. 7, business information for the university recruiting application may be organized to provide one or more special-purpose resume books. These special-purpose resume books may be available to a network of universities and not just to any one university. These special-purpose resume books may also be available to a network of employers and not just to any one employer. In this invention, special-purpose resume books may be created through the establishment of a virtual affiliation. A virtual affiliation may be created by adding a record 200d to the affiliation table 200, and the membership in the virtual affiliation is defined using the affiliation membership database table 600 described above with reference to FIG. 6. Resume books may be defined for virtual affiliations as well as for universities, using the resume book database table 400 described above with reference to FIG. 4. Universities (career center staff and students) and employers may be granted access to these special-purpose resume books in much the same way as the special-purpose job content repositories described above. For example, in some embodiments, a resume book-affiliation database table 700 can include a record 700a-700c for each respective access by a virtual affiliation to a resume book. FIG. 7 shows an illustrative implementation of this organization. It can be readily seen that a plurality of special-purpose resume books can be created network wide and that this provides for many opportunities for universities (career center staff and students) and for employers to interact beyond the scope of a single university.

In some exemplary embodiments of the present invention, the career center means allow career center staff to have their university recruiting context enriched by adding access to multiple and diverse sources of job content repositories. This can enable university career center staff to provide to their students a wide selection of job opportunity postings over and beyond those supplied by employers having a recruiting relationship with the university. In some exemplary embodiments of the present invention, university students can search for job postings across one or more job content repositories.

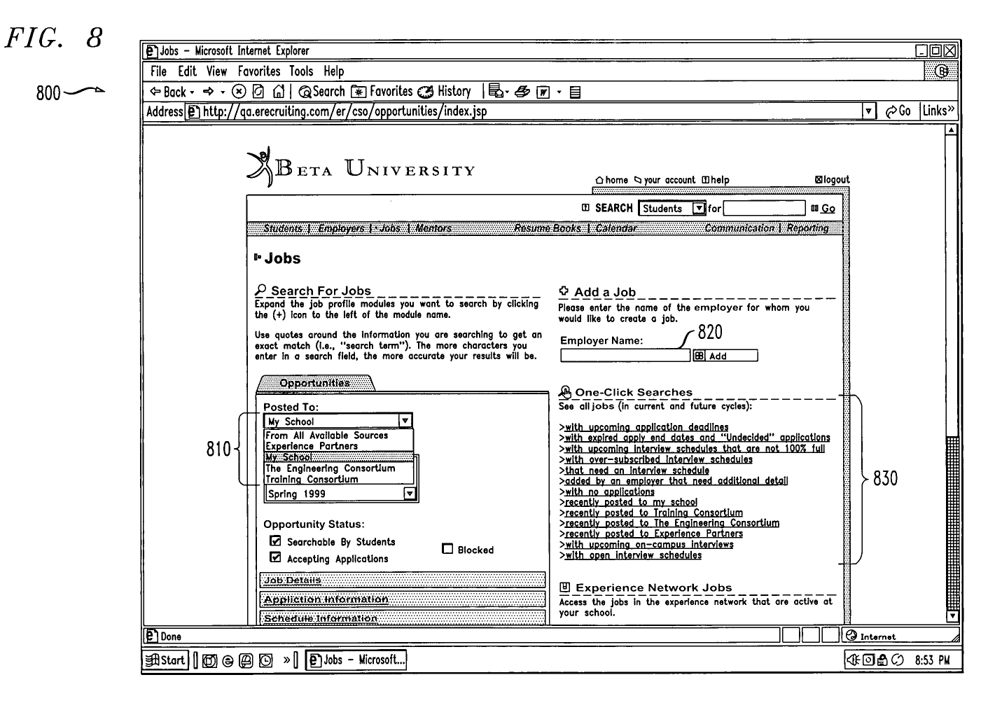

FIG. 8 shows an illustrative implementation of a job opportunity search page 800 that can be displayed in response to a request by either the career center means or the university student means, where the requester (career center staff person or student) can elect to search for job opportunities from a variety of repositories 810, which may include: ‘. . . All Available Sources’, ‘My School’, ‘Experience Partners’, ‘The Engineering Consortium’, and ‘Training Consortium,’ where these choices are examples of possible, different repositories of job opportunity postings. Using the controls of this field 810, the career center staff or student may narrow or broaden the search based upon the relevance of the available sources. FIG. 8 also shows a field 820 in which the requester can enter the name of an employer for which the requester wishes to create a job. Further, a plurality of controls (such as hyperlinks) 830 may be provided to allow the user to request a search using one of a plurality of predetermined search criteria, such as: jobs with upcoming application deadlines, jobs with expired apply end dates and undecided applications, jobs with upcoming interview schedules that are not 100% full, jobs with over-subscribed interview schedules, jobs that need an interview schedule, jobs added by an employer that need additional detail, jobs with no applications, jobs recently posted to the requestor's school, jobs recently posted to training or engineering consortia, jobs associated with a web site sponsor (such as Experience.com), jobs with upcoming on campus interviews, jobs with open interview schedules, and the like.

In some exemplary embodiments of the present invention, the career center means allow the career center staff to organize student resumes from their school into one or more resume books. Resume books enable the collection of student resumes into any of a plurality of themes.

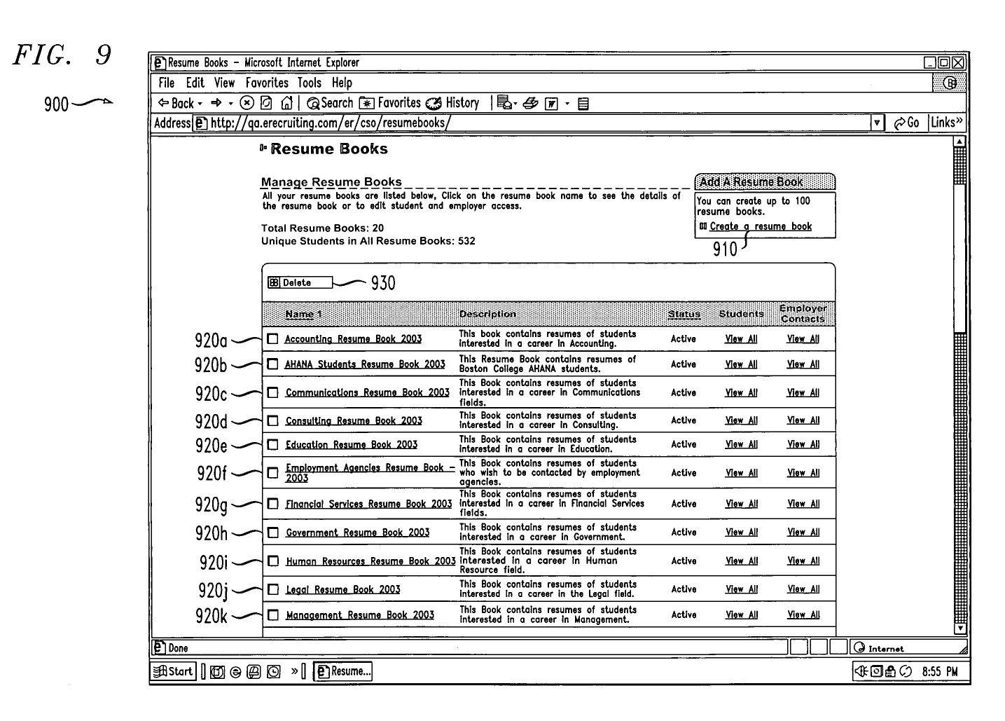

FIG. 9 shows an illustrative implementation of a resume book list 900 for creating and managing the resume books of a particular university. A control (e.g., a hyperlink) 910 enables the user to add a resume book to the list. For each resume book that has already been created, a summary entry 920a-920k is provided, including a checkbox, a title, a description, the status, the students whose resumes are included in the book, and the employer contacts who have access to the book. In this example, the career center staff have created resumes books like ‘Accounting Resume Book 2003’, ‘Education Resume Book 2003’, and ‘Legal Resume Book 2003’ whose contents reflect resumes from students with concentrations in the fields referred to by the resume book titles. by clicking on the hyperlink title field in one of the rows 920a-920k, the details of that particular resume book are displayed, and can be updated. This example is suitable for the creation and population of resume repositories whose content may encompass university students from across the entire network of universities. A delete control 930 may be used to delete a resume book for which the checkbox has been checked.

In some exemplary embodiments of the present invention, the employer means allows employers to establish a master account that is independent in context from any collection of universities. In this fashion, employers may link to their master account any number of university recruiting access accounts that have been established by career center staff at universities where the employer maintains a recruiting relationship. Employers who may have linked their university-specific access accounts may now login to the system only once, yet enjoy the ability to interact with the university recruiting application with the full benefits of access to all linked universities along with all their respective rights and privileges as granted by career center staff.

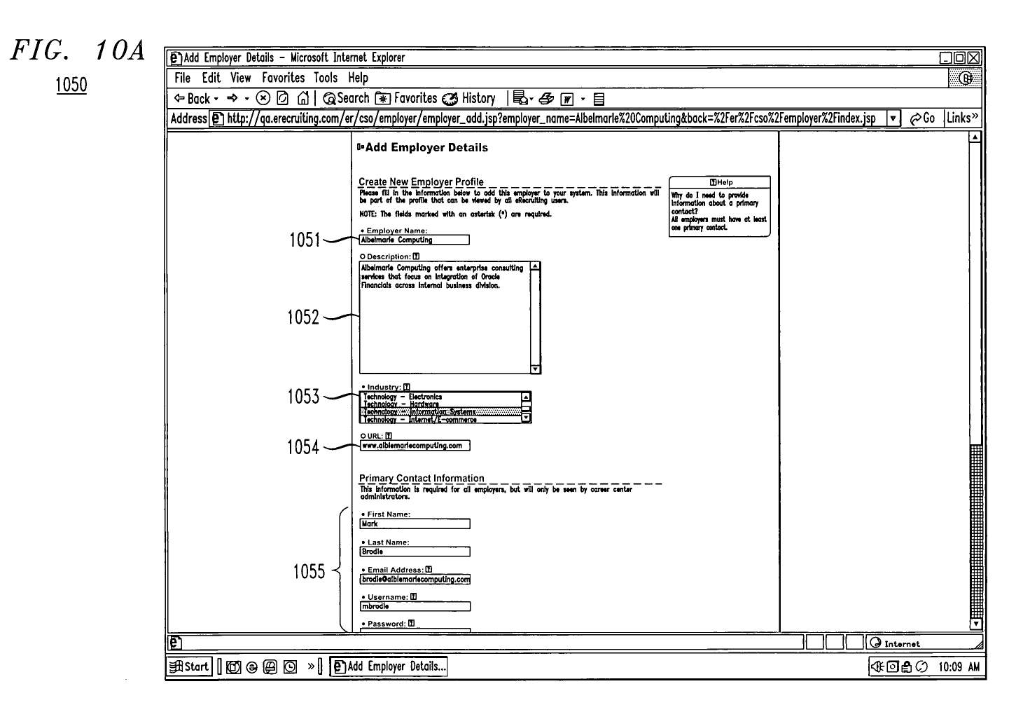

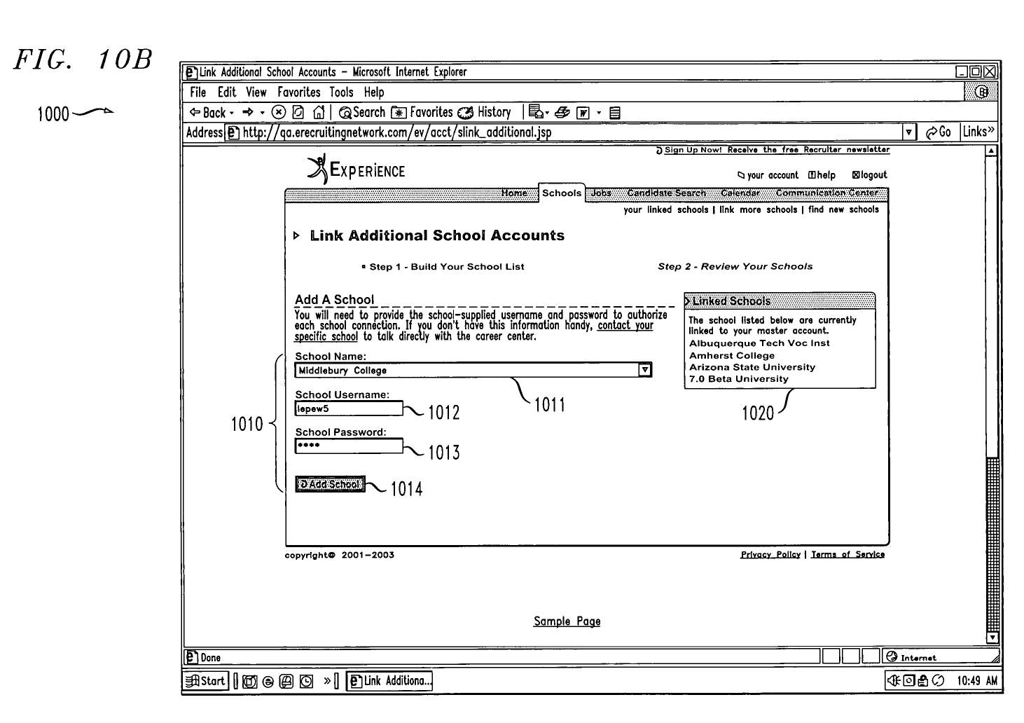

FIG. 10A shows an illustrative implementation of an employer account creation page 1050 where university career center staff can establish employer access accounts. The university career center staff are provided fields 1051-1055 in which to enter employer name, description, industry, web site URL, and contact information, respectively. Although FIG. 10A shows a drop down box for selecting the employer's industry from a predetermined list, a free text field may alternatively be provided.

FIG. 10B shows an illustrative implementation for linking university access accounts to an employer's master account. A portion 1010 of the screen provides inputs for linking the employer to a university, including fields 1011-1013 for inputting the school name, school furnished usemame, and school furnished password, respectively, and a button 1014 for accepting the data. Another portion 1020 of the screen lists the schools to which the current master account is already linked. In this example, the employer is about to link a university access account ‘lepew5’ from Middlebury College where the university access accounts for ‘Albuquerque Tech Vocational Institute’, ‘Amherst College’, ‘Arizona State University’, and ‘7.0 Beta University’ are already linked.

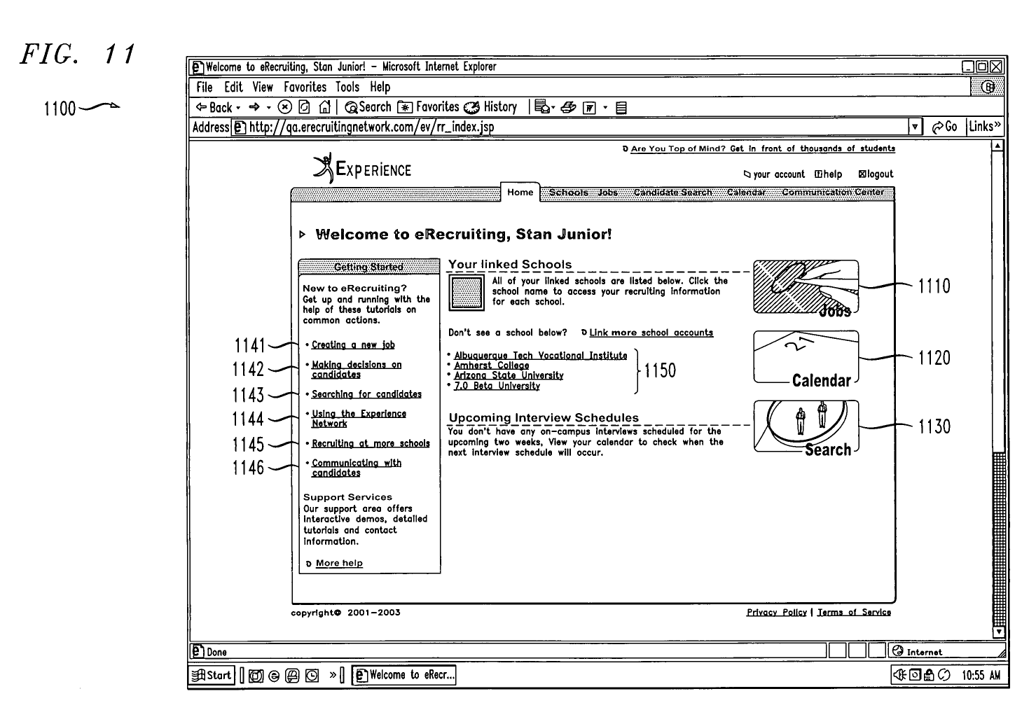

FIG. 11 shows a related exemplary implementation of an employer's home page that appears after the employer has logged in to the university recruiting application using their master account of the employer means. It can be easily seen that the employer sees a fully integrated set of recruiting access accounts, all accessible at any time. Three controls 1110, 1120 and 1130 are provided for accessing information on jobs, calendar and candidate search, respectively. A list 1150 of schools to whom the employer's master account is linked is provided. Clicking on any of the school names causes additional information about the employer's recruiting activities and relationship with that school. A plurality of controls (e.g., hyperlinks or buttons) 1141-1146 are provided for specific employer activities, such as: creating a new job, making decisions on candidates, searching for candidates, using the sponsor's network, recruiting at additional schools, and communicating with candidates, respectively.

In some exemplary embodiments of the present invention, employers may create a single job posting and perform a targeted deployment of that one job to multiple universities where they have a recruiting relationship.

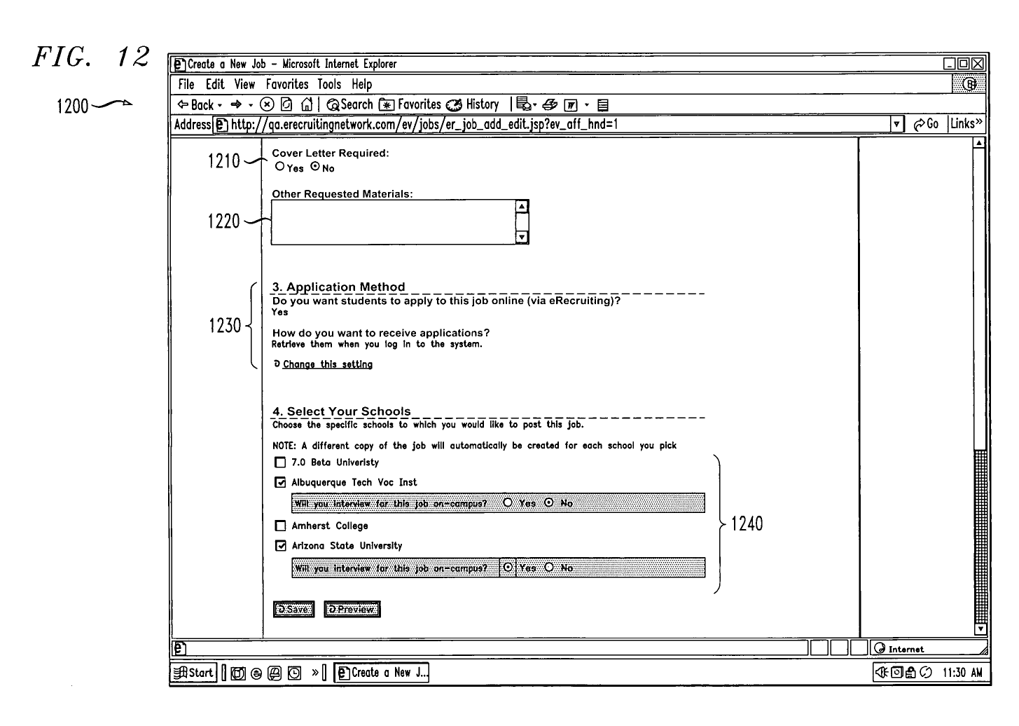

FIG. 12 shows an illustrative implementation of the a screen 1200 displayed by the employer means, that can enable an employer to select which of the employer's linked universities will be associated with the job posting. Field are provided to allow the employer to control several recruiting parameters. Field 1210 allows the employer to specify whether a cover letter by the applicant is required. Field 1220 allows the employer to specify other requested materials in a free-form field. Field 1230 allows the employer to control how the applications are submitted by students and received by the employer. Field 1240 provides a list of the schools with which the employer is linked, from which the employer can select the schools to target for the current job posting. In this example, the employer chooses to deploy the job posting to ‘Albuquerque Tech Vocational Institute’ and ‘Arizona State University’.

In some exemplary embodiments of the present invention, employers may need to annotate newly posted jobs for one or more universities with additional information as required by the career center staff at those universities. Those job postings in need of annotation are marked as ‘Incomplete Jobs’ and are bought to the employer's attention every time their list of active jobs is reviewed.

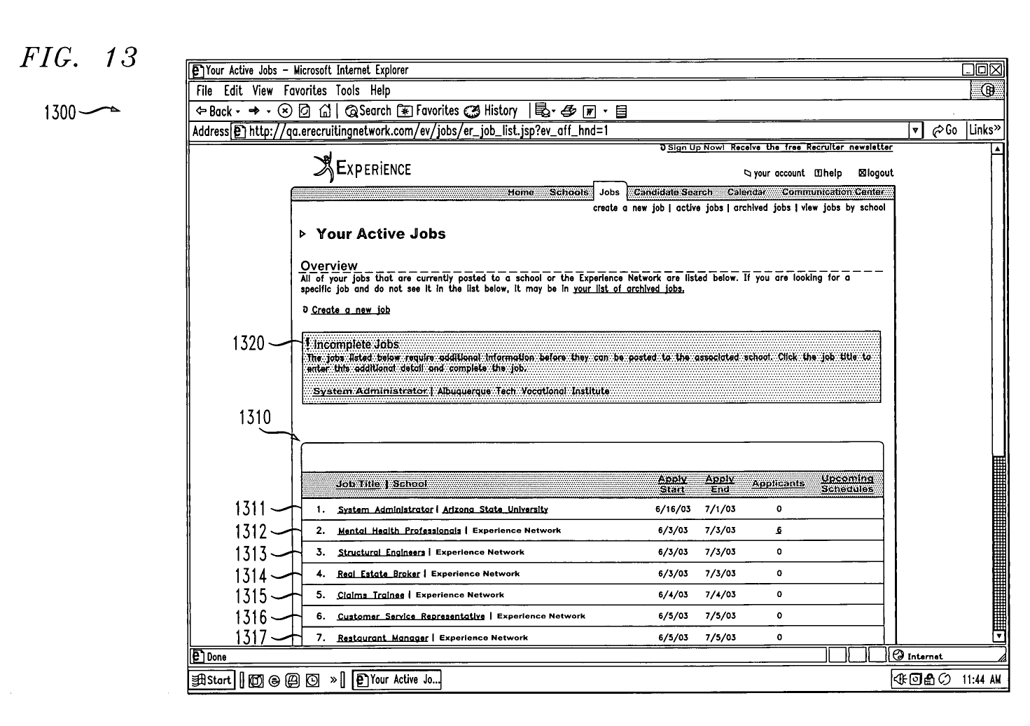

FIG. 13 shows an illustrative implementation of a job posting page displayed by the employer means, listing all the employer's active jobs 1311-1317 in a job list 1310. A warning 1320 is provided if any of the job definitions is missing information. For example, as noted above with reference to FIG. 5, some schools require that additional information specific to those schools be provided. In FIG. 13, job 1311 requires annotation and is therefore not complete. In this example, the ‘System Administrator’ job posting 1311 cannot be deployed to ‘Albuquerque Tech Vocational Institute’ until some additional information is supplied for that university. Warning field 1320 notifies the employer of this problem. This method enables the career center staff at ‘Albuquerque Tech Vocational Institute’ to set the standards for entry of job posting content at the university while still allowing the employer en efficient multiple university deployment of a single job posting. By clicking on the hypertext link at the top of any of the columns, the rows 1311-1317 are sorted by the values in the selected column. For instance, in FIG. 13, the rows 1311-1317 have been sorted by the values of the “Apply End” field.

In some exemplary embodiments of the present invention, employers may create a single job posting and perform a targeted deployment of that one job to multiple universities where they do not have a recruiting relationship. This method enables employers to reach targeted audiences beyond those universities where they have recruiting relationships and potentially across the entire network of universities participating in the university recruiting application.

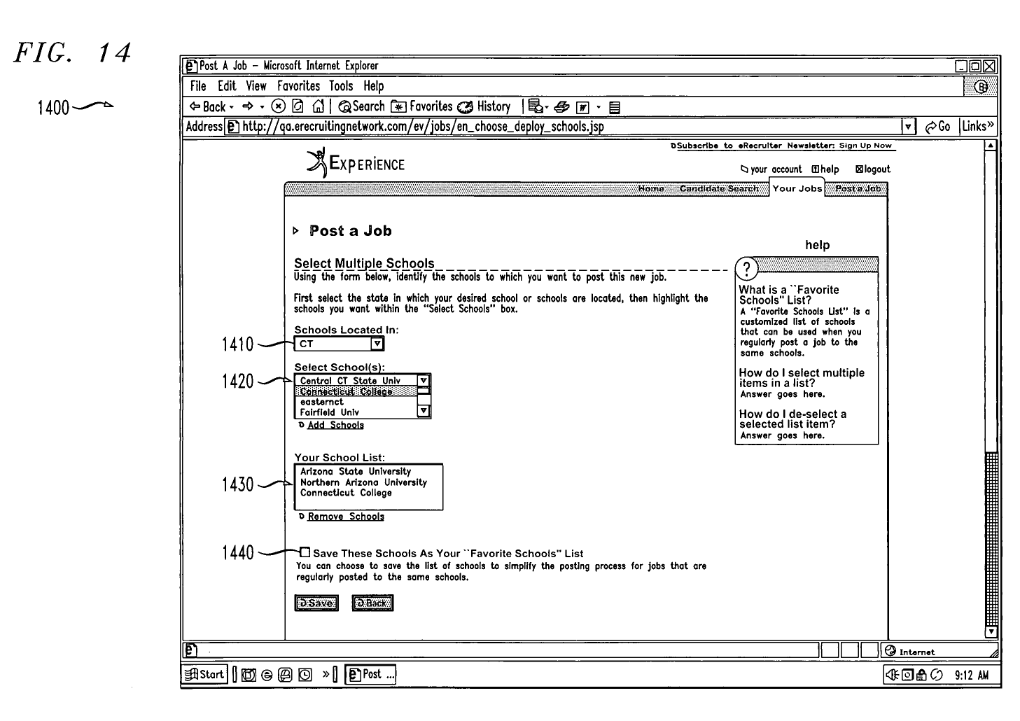

FIG. 14 shows an illustrative implementation of a job posting page displayed by the employer means, to target a job posting to be deployed at ‘Arizona State University’, ‘Northern Arizona University’, and ‘Connecticut College’. Field 1410 allows the employer to search among schools in a particular state. Field 1420 displays the schools in the state selected in field 1410, and allows the employer to add one or more of the schools to the list for this job posting. Field 1430 displays the schools currently listed for this job posting. An option 1440 allows the employer to define a “favorites list” of the schools listed in field 1430, so that same schools can be reused for one or more other job postings in the future. In this fashion, an employer may efficiently create a single job posting and make it available to multiple universities.

In some exemplary embodiments of the present invention, employers can initiate university student resume searches against targeted resume repositories, providing a more effective and more integrated method of identifying qualified candidates from across the network of universities.

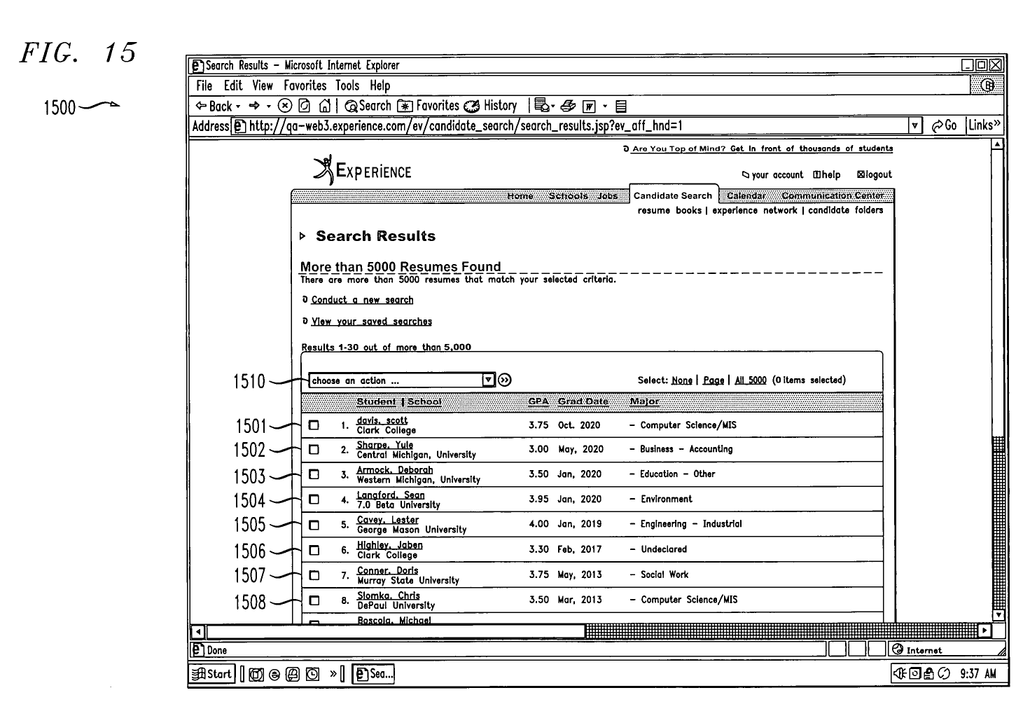

FIG. 15 shows an illustrative implementation of a web page 1500 displayed by the employer means to show the results of an employer initiated university student search, including a list of students whose resumes satisfy the search criteria. Employers may search for university students by specifying matching criteria that may include but are not restricted to: university, major, grade point average (GPA), and graduation date. Summary information entries 1501-1508 may be provided for each respective student, including data such as GPA and/or graduation date and/or major. Each student's name has a checkbox adjacent to it. By checking the checkbox to the left of a particular of the student's name, the employer can take an action with respect to that candidate. Employers may choose actions (using the actions drop-down box 1510) that may include but are not restricted to: invite to apply, download/print documents, and save to a folder. In this example, university students from multiple universities that have met the employer's search criteria are presented.

In some exemplary embodiments of the present invention, employers can obtain an integrated view of all of their job postings.

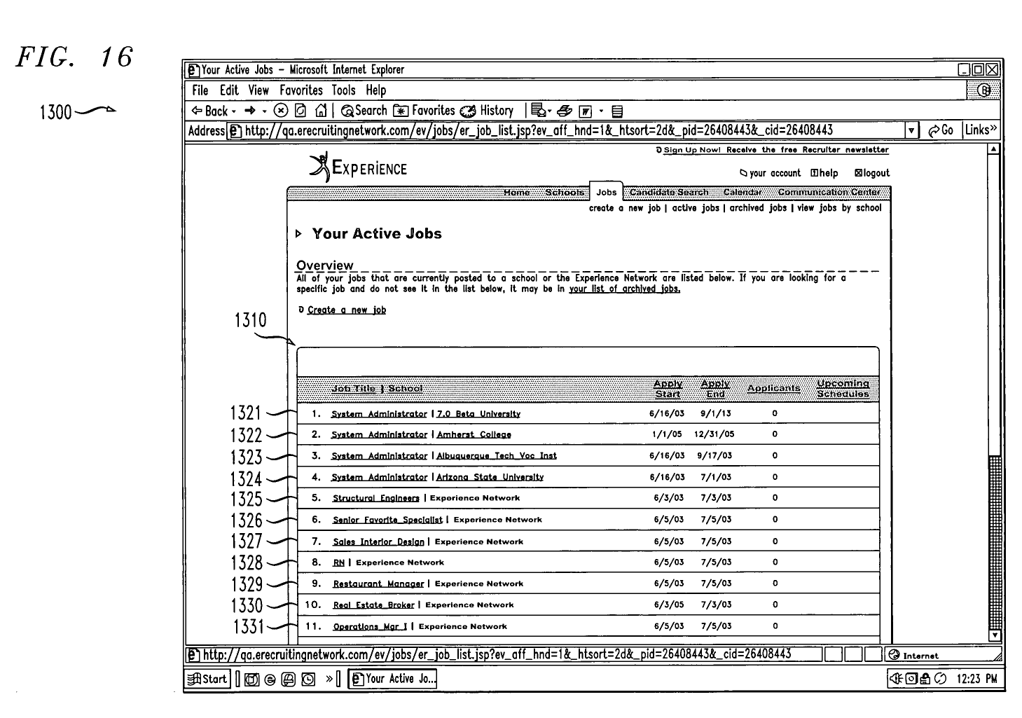

FIG. 16 shows another view of the web page of FIG. 13 with a listing of all of an employer's active jobs. In FIG. 16, all of the posting descriptions are complete, so the warning field 1320 is not displayed. The listing includes, for example, job postings 1321-1324 that have been deployed to linked universities as is the case with the 'System Administrator’ job posting for ‘Albuquerque Tech Vocational Institute’, ‘Amherst College’, ‘Arizona State University’, and ‘7.0 Beta University’. The listing also includes job postings 1325-1331, for example, the ‘Structural Engineer’ and Sales Interior Design’ job postings that have been deployed to the ‘Experience Network’ a targeted job content repository. From this view, the employer can efficiently and effectively interact with and manage all job postings.

In some exemplary embodiments of the present invention, employers can obtain an integrated view of all applicants across all universities for any job posting.

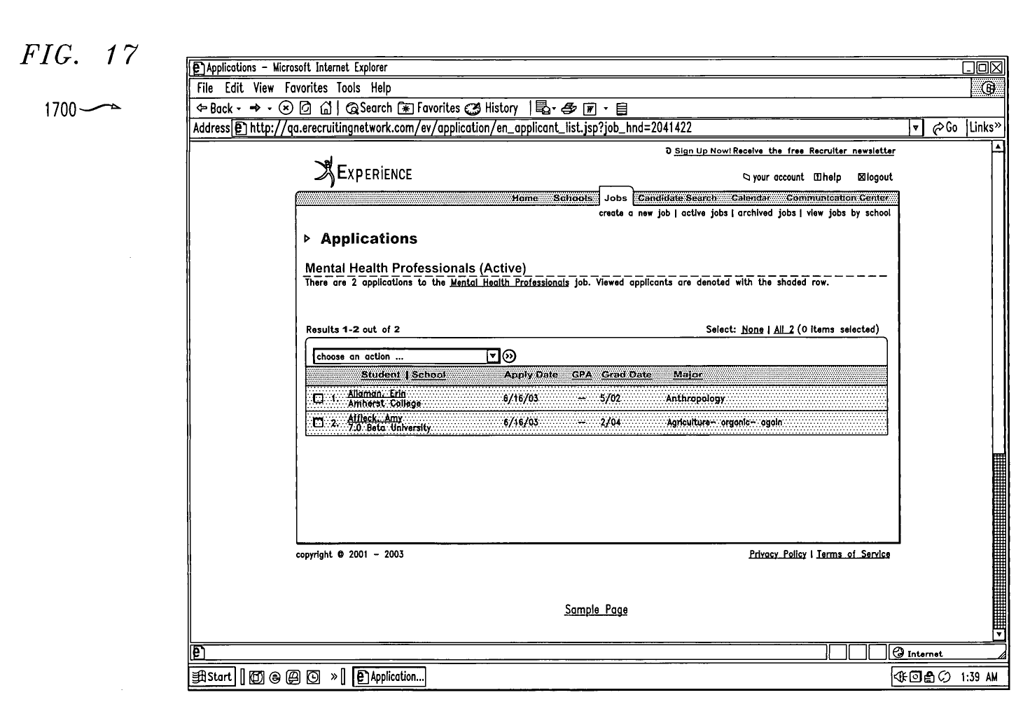

FIG. 17 shows an illustrative implementation of a listing 1700 of all applicants for the ‘Mental Health Professionals’ job posting, as displayed by the employer means. In this example, students from ‘Amherst College’ and ‘7.0 Beta University’ have applied to this job. From this view, the employer can efficiently and effectively interact with and manage all job applications. For a selected set of job applicants employers may choose an action that includes but is not restricted to: accept the application, decline the application, send an email to the applicant, and download/print application documents

In some exemplary embodiments of the present invention, employers can obtain an integrated view of all recruiting events across all universities with which they have recruiting relationships.

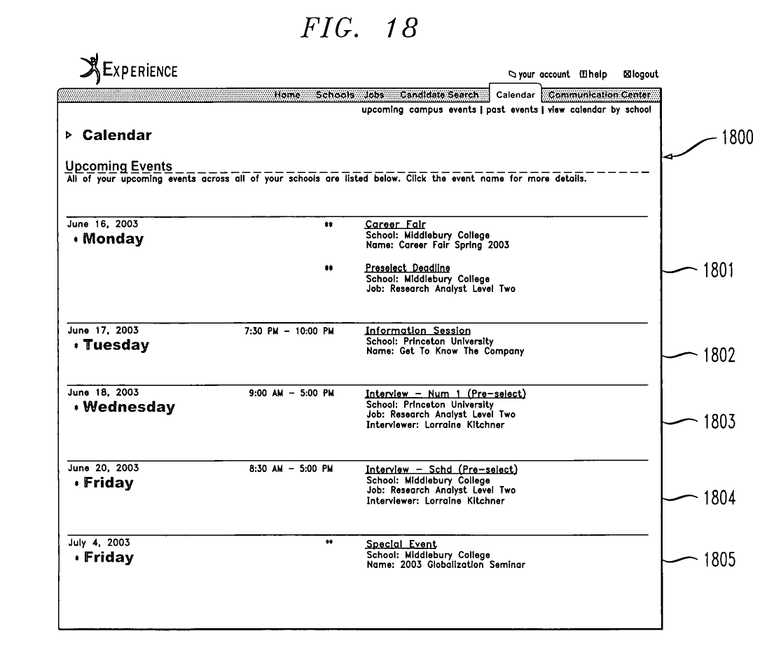

FIG. 18 shows an illustrative implementation of an employer's calendar 1800 of recruiting events 1801-1805, as displayed by the employer means. In this example, the employer sees that on Monday there is a career fair and an application deadline at Middlebury College. The employer also sees an Interview session at Princeton University on Tuesday and an interview there on the following day. In this manner, an employer can easily manage the many recruiting activities at all universities at any time.

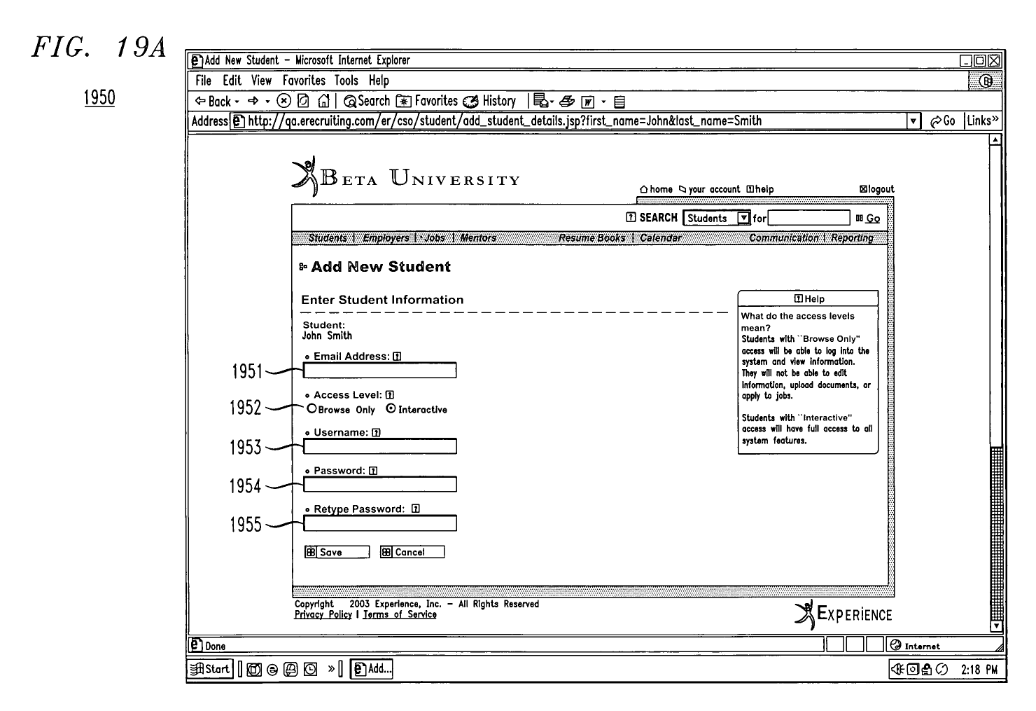

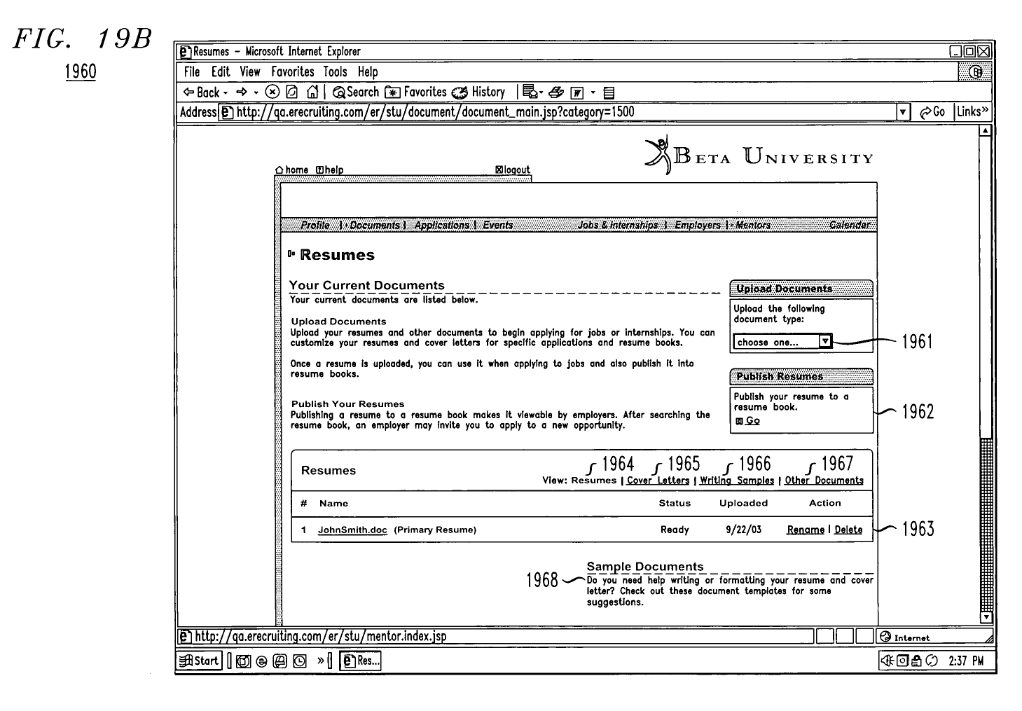

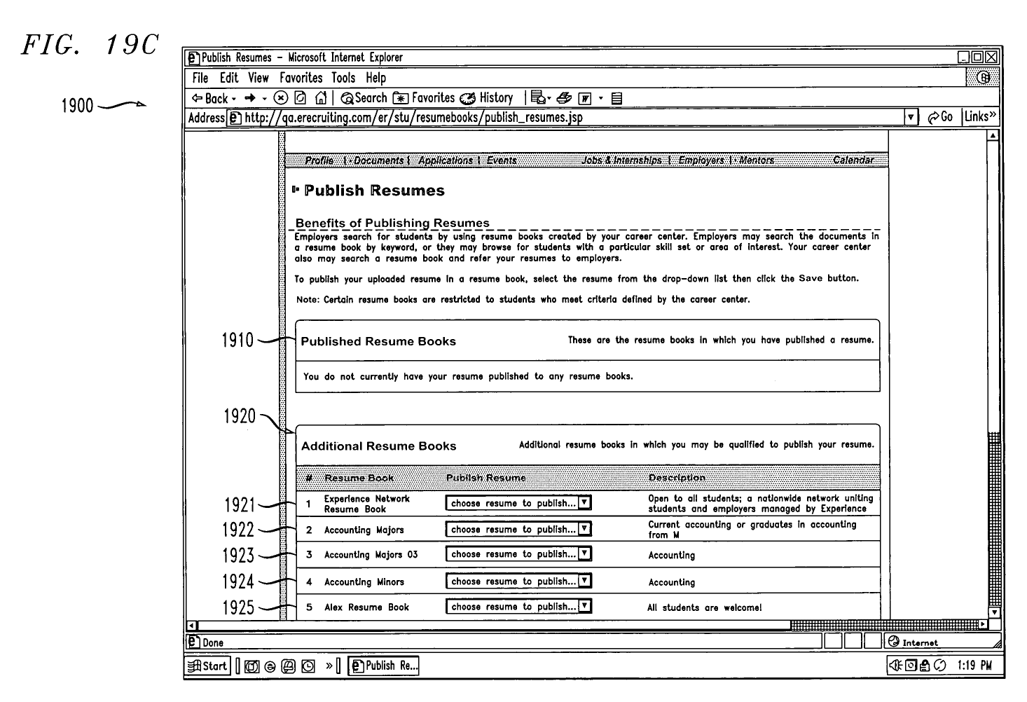

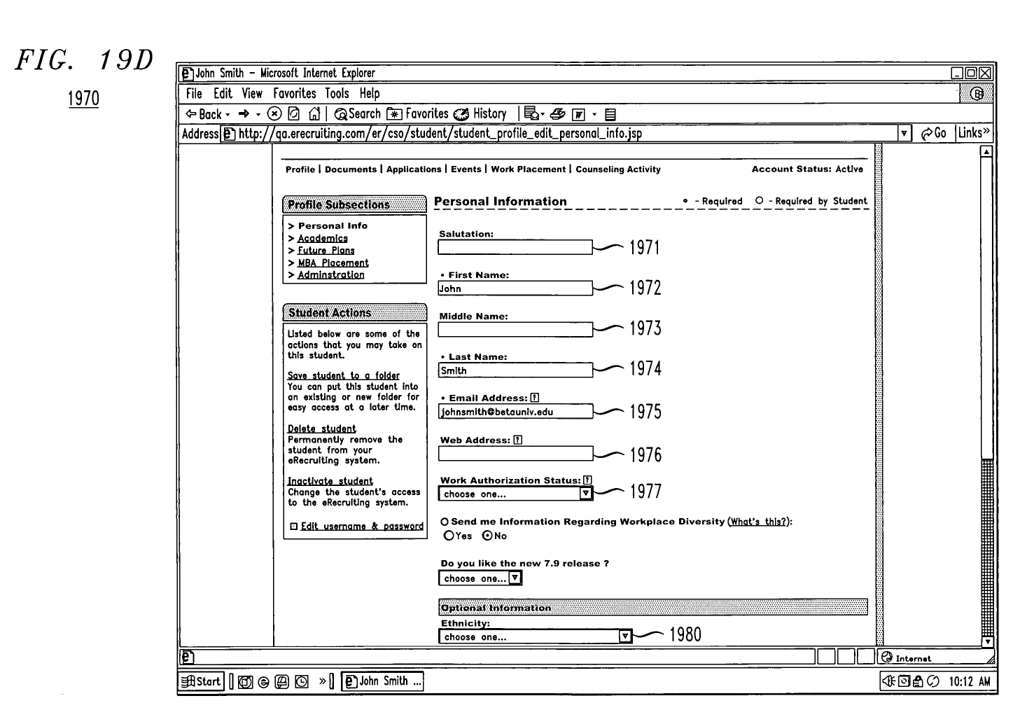

FIG. 19A shows an illustrative implementation of a student account creation page 1950 where university career center staff can establish student access accounts. Fields 1951-1954 are provided for entering the student's email address, access level, username and password, respectively. The access level may control whether the student has read-only access to information in the database, or interactive access, which enables the student to edit information, upload documents and/or apply to jobs.

In some exemplary embodiments of the present invention, university students may publish their resumes to one or more resume books. Resume books may be a seen as a possible representation of targeted resume repositories.

FIG. 19B shows an illustrative implementation of a document management page 1960 where university students may upload resumes, cover letters, writing samples, and other related job application materials. The page includes a control 1961 for uploading a document, a control 1962 for publishing a resume to a resume book, and a display area for listing all of the documents currently on file for that student. By selecting topics 1964 to 1967, the student can view resumes, cover letters, writing samples or other documents, respectively. A sample document field 1968 allows the student to view sample document templates.

FIG. 19C shows a screen display 1900 of an illustrative implementation of a screen displayed by the university student means, in which a university student may choose to publish a resume to one or more targeted resume books. A field 1910 lists all of the resume books in which the student has published his or her resume. Another field 1920 includes rows 1921-1925 containing the names of additional resume books in which the student can choose to publish his or her resume. The student is allowed to have multiple resumes on file. The drop down box allows the student to choose the resume to publish, assuming that the student has uploaded more than one resume. In this example, the student can see resume books organized for his university, such as the ‘Accounting Majors’ resume book. The student can also choose to publish a resume to the ‘Experience Network Resume Book’, one of many possible network-wide resume repositories. In this fashion, the student can efficiently upload a single resume and deploy it to one or more repositories.

FIG. 19D shows an illustrative implementation of a student profile data entry form 1970 where the university student may enter descriptive information including but not limited to personal information, academic information, future plans, and the like. FIG. 19D shows fields for entering a salutation 1971, student first name 1972, middle name 1973, last name 1974, email address 1975, web page 1976, work authorization status 1977 and optional information such as ethnicity 1980.

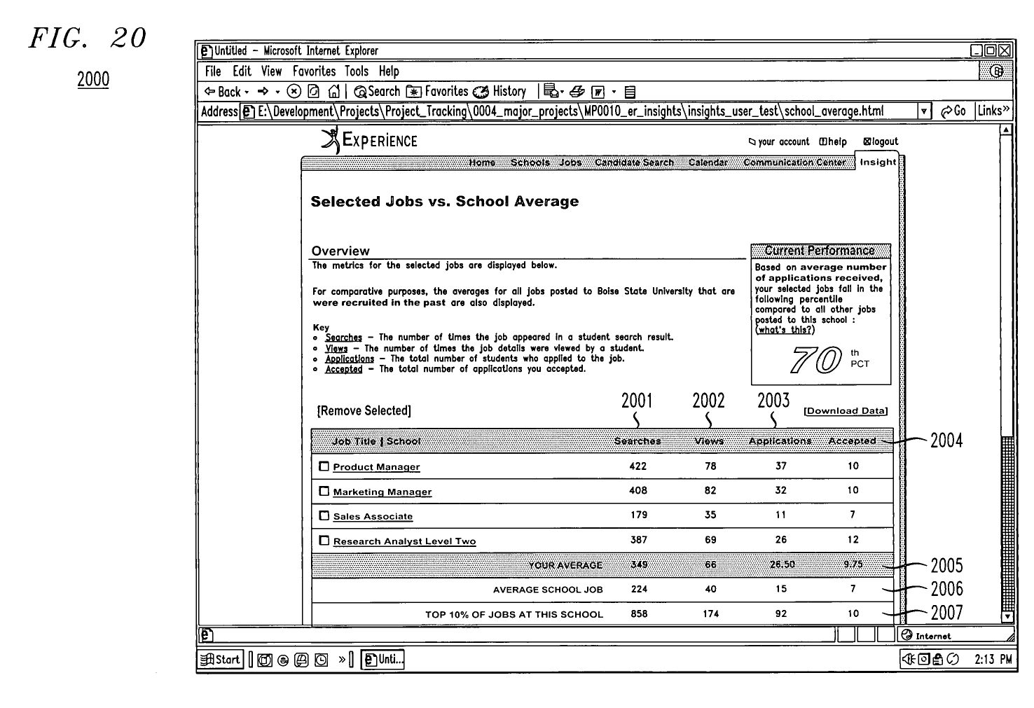

Some embodiments advantageously collect, aggregate, and summarize data about employer, student, and job activities across the entire university recruiting system and present the data to university career center staff, employers and students, providing them with deeper insight into the effectiveness of the various recruiting activities. FIG. 20 shows an illustrative implementation of a job metrics summary page 2000, where various statistics about an employer's jobs are presented.

In FIG. 20, all of an employer's jobs are listed. For each job the following sums are presented:

Searches 2001 —the total number of searches by individual student account holders where the job was included in a job search result set.

Views 2002 —the total number of times that individual student account holders selected a specific job and viewed its job profile page.

Applications 2003 —the total number of applications by students for a specific job.

Accepted 2004 —the total number of students who have been accepted for interviews for a specific job.

Also presented in FIG. 20 is a simple average 2005 of each of these values across all of the employer's jobs in the list. Simple averages for these values across all jobs at a particular university are presented under the section 2006 titled “Average School Job”. Simple averages for these values across the top 10% of jobs across the same university are presented under the section 2007 entitled “Top 10% Of Jobs At This School”. In FIG. 20, top 10% refers to the top 10% of all jobs at a particular school as ordered by the total number of job applications. In a similar way, employer job metrics can be summarized to reflect a comparison of an employer's list of jobs and their averages as compared with averages derived from all jobs across the entire university recruiting system. The ability to aggregate and summarize data is not limited to employer job metrics, but rather, more broadly covers any activity data representative of activity that describes employers, students, and jobs across the entire university recruiting system.

The present invention may be embodied in the form of computer-implemented processes and apparatus for practicing those processes. The present invention may also be embodied in the form of computer program code embodied in tangible media, such as floppy diskettes, read only memories (ROMs), CD-ROMs, hard drives, ZIP™ disks, memory sticks, or any other computer-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over the electrical wiring or cabling, through fiber optics, or via electromagnetic radiation, wherein, when the computer program code is loaded into and executed by a computer, the computer becomes an apparatus for practicing the invention. When implemented on a general-purpose processor, the computer program code segments configure the processor to create specific logic circuits.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A university recruiting system and database for the collaboration of university career center staff, university students, and employers, comprising:
career center means for enabling career center staff to create and manage university student accounts and employer accounts;
employer means for enabling the employers to create job postings, for enabling the employers to deploy targeted job postings across multiple schools, for enabling the employers to access university student profiles and conduct candidate search across multiples schools, and for enabling the employers to manage job applications accessible by multiple schools; and
university student means for enabling the students to create student profiles, for enabling the students to upload job search related documents, and for enabling the students to perform job searches across multiple job listings and job content repositories.

2. The system of claim 1, further comprising means for associating targeted job content repositories across multiple universities.

3. The system of claim 1, further comprising means for providing a plurality of employers with access to targeted resume repositories.

4. The system of claim 1, further comprising means for enabling employers to establish a master account, to authenticate themselves and to access multiple university employer accounts.

5. The system of claim 4, further comprising means to enable one of the employers to link multiple university accounts to the master account of that employer.

6. The system of claim 1, wherein the employer means include means for enabling an employer to post information describing a job for access in job content repositories of a plurality of universities with which the employer has a recruiting relationship.

7. The system of claim 1, wherein the employer means include means for employers to augment job posting details for a specific university context using custom data fields that have been defined by the university career center staff.

8. The system of claim 1, further comprising means for enabling an employer to create a job posting and initiate a targeted deployment of the job posting to job content repositories of a plurality of universities with which the employer does not have a recruiting relationship.

9. The system of claim 1, wherein the employer means include means for enabling the employers to perform an integrated search for candidates across multiple university candidate profile repositories.

10. The system of claim 1, wherein the employer means include means for enabling the employers to obtain an integrated view of the employer's job postings across all of a plurality of university repositories.

11. The system of claim 1, wherein the employer means include means for enabling the employers to obtain an integrated view of job applicants across all of a plurality of university repositories.

12. The system of claim 1, wherein the employer means include means for enabling the employers to obtain an integrated view of recruiting events across all of a plurality of university repositories.

13. The system of claim 1, wherein the university student means include means for enabling students to upload resumes and job search related documents and to initiate targeted deployment of the resumes and job search related documents to a plurality of candidate profile repositories.

14. The system of claim 1, wherein the university student means include means for enabling students to perform an integrated job posting search across a plurality of job content repositories.

15. The system of claim 1 further comprising:
means for collecting data related to student accesses to information concerning individual jobs and information concerning applications for individual jobs, wherein data collected by the date collecting means are aggregated, analyzed, and displayed to at least one of the group consisting of university career center staff, employers, and students.

16. A computer readable medium encoded with compute program code, wherein, when the computer program code is executed by at least one processor, the at least one processor performs a computer implemented method for the collaboration of university career center staff, university students, and employers, the computer readable medium comprising:
career center means for causing the processor to enable career center staff to create and manage university student accounts and employer accounts;
employer means for causing the processor to enable the employers to create job postings, to enable the employers to deploy targeted job postings across multiple schools, to enable the employers to access university student profiles and conduct candidate search across multiples schools, and to enable the employers to manage job applications accessible by multiple schools; and
university student means for causing the processor to enable the students to create student profiles, to enable the students to upload job search related documents, and to enable the students to perform job searches across multiple job listings and job content repositories.

17. The computer readable medium of claim 16, further comprising means for causing the processor to associate targeted job content repositories across multiple universities.

18. The computer readable medium of claim 16, further comprising means for causing the processor to provide a plurality of employers with access to targeted resume repositories.

19. The computer readable medium of claim 16, further comprising means for causing the processor to enable employers to establish a master account, to authenticate themselves and to access multiple university employer accounts.

20. The computer readable medium of claim 19, further comprising means for causing the processor to enable one of the employers to link multiple university accounts to the master account of that employer.

21. The computer readable medium of claim 16, wherein the employer means include means for causing the processor to enabling an employer to post information describing a job for access in job content repositories of a plurality of universities with which the employer has a recruiting relationship.

22. The computer readable medium of claim 16, wherein the employer means include means for causing the processor to augment job posting details for a specific university context using custom data fields that have been defined by the university career center staff.

23. The computer readable medium of claim 16, further comprising means for causing the processor to enable an employer to create a job posting and initiate a targeted deployment of the job posting to job content repositories of a plurality of universities with which the employer does not have a recruiting relationship.

24. The computer readable medium of claim 16, wherein the employer means include means for causing the processor to enable the employers to perform an integrated search for candidates across multiple university candidate profile repositories.

25. The computer readable medium of claim 16, wherein the employer means include means for causing the processor to enable the employers to obtain an integrated view of the employer's job postings across all of a plurality of university repositories.

26. The computer readable medium of claim 16, wherein the employer means include means for causing the processor to enable the employers to obtain an integrated view of job applicants across all of a plurality of university repositories.

27. The computer readable medium of claim 16, wherein the employer means include means for causing the processor to enable the employers to obtain an integrated view of recruiting events across all of a plurality of university repositories.

28. The computer readable medium of claim 16, wherein the university student means include means for causing the processor to enable students to upload resumes and job search related documents and to initiate targeted deployment of the resumes and job search related documents to a plurality of candidate profile repositories.

29. The computer readable medium of claim 16, wherein the university student means include means for causing the processor to enable students to perform an integrated job posting search across a plurality of job content repositories.

30. The computer readable medium of claim 16 further comprising:
means for causing the processor to collect data related to student accesses to information concerning individual jobs and information concerning applications for individual jobs, wherein collected data are aggregated, analyzed, and displayed to at least one of the group consisting of university career center staff, employers, and students.
